(19) United States
(12) Patent Application Publication
(10) Pub. No.: US 2009/0130412 A1
(43) Pub. Date: May 21, 2009

(54) Method of transformation of bridging organic groups in organosilica materials

(76) Inventors: Benjamin David Hatton, Hamilton (CA); Geoffrey Alan Ozin, Toronto (CA); Doug Dragan Perovic, Toronto (CA); Kai Manfred Martin Landskron, Bethlehem, PA (US)

Correspondence Address: Ralph A. Dowell of DOWELL & DOWELL P.C., 2111 Eisenhower Ave, Suite 406, Alexandria, VA, 22314, US

(21) Appl. No.: 11/921,325

(22) PCT Filed: Sep. 22, 2005
(86) PCT No.: PCT/CA2005/001438

§ 371 Date: Aug. 26, 2008

Related U.S. Application Data
(60) Provisional application No. 60/611,703, filed on Sep. 22, 2004.

(51) Int. Cl. B32B 15/02; H01B 1/12; H01B 1/02; B32B 19/00

(52) U.S. Cl. 428/220; 252/519.3; 252/519.31; 428/702

(57) ABSTRACT

This invention relates to a chemical transformation of the bridging organic groups in metal oxide materials containing bridging organic groups, such as bridged organosilicas, wherein such a transformation greatly benefits properties for low dielectric constant (k) applications. A thermal treatment at specific temperatures is shown to cause a transformation of the organic groups from a bridging to a terminal configuration, which consumes polar hydroxyl groups. The transformation causes k to decrease, and the hydrophobicity to increase (through ‘self-hydrophobization’). As a result of the bridge-terminal transformation, porous organosilica films are shown to have k<2.0, E>6 GPa, do not require additional chemical surface treatment for dehydroxylation (hydrophobicity).

### CROSS REFERENCE TO RELATED U.S APPLICATION

This patent application relates to, and claims the priority benefit from, U.S. Provisional Patent Application Ser. No. 60/611,703 filed on Sep. 22, 2004, which is incorporated herein by reference in its entirety.

### FIELD OF THE INVENTION

This invention relates to a chemical transformation of the bridging organic groups in metal oxide materials containing bridged organosilicas, wherein such a transformation greatly benefits properties for low dielectric constant (k) microelectronics applications. A thermal treatment at specific temperatures is shown to cause a transformation of the organic groups from a bridging to a terminal configuration. The transformation causes k to decrease, and the hydrophobicity to increase (through ‘self-hydrophobization’). As a result, porous films do not require chemical surface treatment for dehydroxylation, and maintain good mechanical stiffness and strength.

### BACKGROUND OF THE INVENTION

Periodic mesoporous materials (ie; MCM-41) represent a special class of porous structures synthesized using a cooperative self-assembly of an organic supramolecular template and a polymerizable inorganic (or organic/inorganic hybrid) material (see Kresge et al 1992). These materials have a huge potential for novel applications in catalysis, molecular separation, nanocomposite design, chemical sensing, and drug delivery (see Stein et al 2003).

Silica, including periodic mesoporous silica, consists of condensed SiO₄ building units linked via Si—O—Si bonds. One way to incorporate organic groups into the mesostructure of mesoporous silica is using a combination of an organically terminated silicate precursor (such as RSi(OEt)₃, where R is an organic group) and a silicate precursor such as Si(OEt)₄ (TEOS). However, a significantly larger amount of organic groups can be incorporated using bridged silsesquioxane precursors of the form Si—R—Si, due to the greater network connectivity. Thus, in this context, periodic mesoporous organosilicas (PMOs) are bridged organosilicas as a periodic mesoporous framework. PMOs consist of SiO₃R or SiO₂R₂ building blocks, where R is a bridging organic group. These materials are scientifically and technologically important because the bridging organic groups inside the pore walls can provide distinct chemical and physical properties (see Asefa et al 1999, Asefa et a/2002, and Inagaki et al U.S. Pat. No. 6,248,686).

PMOs have many potential applications for catalysis, chemical sensing, biological sensing, drug delivery and nanocomposite design because of the control of chemical functionality. Also, a greater thermal and mechanical stability is achieved for an organosilica containing bridging groups compared to terminal groups, because the silicate network remains more fully connected (see Shea et al 1992).

There are many potential applications for PMO films with controlled porosity, pore size and organic composition. One very important potential application of porous organosilicate films is in the microelectronics industry as dielectric materials, which surround and insulate the interconnect wiring on a chip. The main requirement (among many) is to have a dielectric constant (k) lower than current standards (ie; silica, k ˜3.8), to reduce the capacitive coupling of the system and prevent signal ‘cross talk’ between wires. The intra- and interlayer capacitances cause signal delays that increase dramatically as the device and interconnect densities continue to rapidly increase, as shown by Moore's Law. Therefore, as device sizes approach 90 nm, 65 nm, 45 nm and below, suitable materials with ultra-low dielectric constants <2.0 are urgently required (see Maex et al 2003).

There are many property requirements for a material to be suitable for current industrial processes; mechanical strength, thermal stability, adhesion, resistance to moisture adsorption and overall cost are among the most important. Porosity reduces k, since kₐᵢᵣ ˜1.0, but achieving a low k value without becoming too porous (ie; >75 vol %) and mechanically weak is an important materials challenge. Ultimately, dielectric films must be mechanically strong enough to withstand the chemical mechanical polishing (CMP) stage of processing.

Most materials under development for low-k applications can be broadly classified as porous silica-based or polymeric/organic-based materials. The latter includes fluorinated polymers such as PTFE, which have inherently low values of k, but generally suffer from problems associated with thermal stability (see Miller et a/1999). Porous silica materials include fluorinated silica, methyl-terminated silica (MSSQ), hydrogen-terminated silica (HSSQ), and surface-treated porous silica. The porous structures are generally xerogels and aerogels (non-uniform pores, non-periodic porous structure), porogen-templated (uniform pores, non-periodic), or the self-assembled, templated MCM-type materials (uniform pores, periodic).

Porous silica by itself, either xerogel or MCM-type, always requires some type of dehydroxylation surface treatment to replace the numerous hydroxl groups with organic species (ie; terminal methyl), known as ‘capping’ or methylsilation, to avoid the strong hydrophilic attraction to highly-polar water molecules. Reactive species such as hexamethyldisilazane (HMDS) or trimethylsilylchloride (TMSC) are commonly used to react with silanol (Si—OH group) protons to form terminal trimethisilyl surface groups.

Incorporating organic groups into silica also lowers k, and increases the hydrophobicity. However, fluorinated silica, MSSQ and HSSQ materials generally suffer from a relatively low mechanical strength, due to the disconnected structure associated with the large amount of terminal groups, and can often also require a capping treatment.

Asefa et a/2000 demonstrated that a methene-bridged PMO can undergo a transformation of the organic groups from bridged to terminal orientation, by means of reacting with a nearby —OH (silanol) group. Although one Si—R—Si bridge is broken, another Si—O—Si bridge is formed, to keep network connectivity. They determined that this transformation is controlled very specifically temperature, and occurs between 400-600° C. Kuroki et a/2002 also showed a similar thermal transformation behaviour for a 1,3,5-phenylene PMO. However, in both cases they made their experiments only on powder materials, and showed no evidence of the increase in hydrophobicity, or the effects on the dielectric constant.

Brinker et al (U.S. Pat. No. 5,858,457) demonstrated ‘evaporation-induced self-assembly’ (EISA) for mesoporous silica films, in which a hydrolyzed silicate solution is mixed with surfactant and an excess of volatile solvent. However, they did not apply this method to bridged organosilicas, or demonstrate any properties of such materials.

Lu et al (2000) demonstrated the first PMO thin films for a bridged ethenesilica (—CH₂CH₂—) material using the EISA method. The films were heat treated at 350° C. under nitrogen to remove the surfactant template, then exposed to a vapour treatment of HMDS to make the films hydrophobic and prevent water adsorption. They measured the dielectric constant of a 75:25 molar ratio film (organosilane:TEOS) to be 1.98. However, no additional thermal treatments were performed to cause a ‘bridge-terminal’ transformation, and there were no demonstrated changes in hydrophobicity or the dielectric constant due to thermal treatments.

Nakata et al (U.S. Pat. No. 6,558,747) prepared thin films of polysilsesquioxanes, including various bridged polysilsesquioxanes, for low dielectric applications. However, these films are non-porous, and though they require heat treatment in an inert atmosphere, the temperatures are restricted to a maximum of 400° C., to preserve the Si—C bonds. Therefore, there was no evidence of a bridge-terminal transformation, or the related effects on the physical properties of the films.

Landskron et al (2003) synthesized PMOs composed of interconnected Si₃(CH₂)₃ 3-rings and showed that a heat treatment at 400° C. (under nitrogen) can cause a bridge-terminal transformation of the methene groups, to cause a lowering of the dielectric constant. However, they did not demonstrate the effects of further heat treatments at temperatures >400° C., and did not test the hydrophobicity.

### SUMMARY OF THE INVENTION

The present invention overcomes deficiencies in prior art by providing the means of treating a range of metal oxide materials containing bridging organic groups (such as PMOs and non-porous bridged organosilicas) such that they undergo a chemical transformation whereby the bridging organics become terminal groups. To amplify, it is known that the transformation of bridging organic groups into terminal groups occurs in certain bridged organosilicas at specific temperatures beyond those of conventional template removal (calcination) (see Asefa et al 2000). The chemical transformation eliminates polar hydroxyl groups (ie; Si—OH).

Herein the inventors demonstrate this transformation simultaneously causes a decrease in k and increases the hydrophobicity of the material through ‘self-hydrophobization’, while maintaining the organic content, porous structure, and network connectivity. In particular, it has been found that the hydroxyl-consuming reaction greatly benefits the properties of bridged organosilica films (such as PMOs) for low-k applications.

In one aspect of the invention there is provided a method of treating a material comprising a metal oxide framework containing organic groups each bridging at least two metal atoms to increase a hydrophobicity and decrease a dielectric constant of said material, the method comprising the step of;

applying an effective treatment to cause a hydroxyl group-consuming chemical transformation of at least some of said organic groups from a bridging to a terminal configuration, wherein applying said effective treatment increases a hydrophobicity of said material and decreases a dielectric constant of said material.

In another aspect of the invention there is provided a material comprising a metal oxide framework containing organic groups produced by a method comprising the steps of:

synthesizing a metal oxide framework containing organic groups bridging at least two metal atoms; and

applying an effective treatment to cause a hydroxyl group-consuming chemical transformation of at least some of said organic groups from bridging to a terminal configuration.

The present invention provides a periodic porous organosilica material wherein no other terminal groups are present but terminal organic groups bound to the Si atom by a Si—C bond.

### BRIEF DESCRIPTION OF THE DRAWINGS

The method of chemical transformation of metal oxide materials containing bridged organic groups will now be described in accordance with the present invention. By way of example only, reference is made to the accompanying drawings, in which:

FIG. 1 shows a schematic cross-section of a film on a substrate

FIG. 2 is a schematic illustration of the chemical bonding associated with the thermally-induced transformation of an organic group from the bridging to terminal conformation.

FIG. 3 shows the silsesquioxane (organosilane) precursors used for PMO films.

FIG. 4 shows SEM images of calcined (300° C.) PMO films fractured in cross-section; (a) methene, (b) ethene, (c) 3-ring, and (d) 3-ring/MT₃ hybrid.

FIG. 5 shows TEM images (200 kV) of calcined (300° C.) PMO films; (a) silica, (b) methene, (c) ethene, and (d) 3-ring.

FIG. 6 shows powder x-ray diffraction (PXRD) spectra of the calcined (300° C.) PMO films.

FIG. 7 shows ²⁹Si MAS NMR spectra of the calcined (300° C.) PMO films, (a) methene, (b) ethene and (c) 3-ring PMO.

FIG. 8 shows (a) ²⁹Si MAS NMR, and (b) ¹³C MAS NMR spectra for the ethene PMO films as a function of temperature.

FIG. 8c shows ¹³C NQS spectra taken for samples treated at 500° C. at three delay times of d3=1 μs, 10 μs, and 50 μs.

FIG. 9 shows ²⁹Si MAS NMR spectra of the 3-ring PMO at temperatures of 300° C. (A), 400° C. (B), 500° C. (C), 600° C. (D) and 700° C. (E).

FIG. 10 shows the change in (100) d-spacing with organic content (molar fraction F) for the methene, ethene and 3-ring PMO films.

FIG. 11 shows the dielectric constant (k) as a function of the organic content (molar fraction F), and heat treatment temperature (300° C. calcination+thermal treatments) for the (a) methene, (b) ethene, and (c) 3-ring PMO.

FIG. 12 shows the effect of exposure to humid environments (80% RH, 1 d) on the dielectric constant (k) of calcined (300° C.) methene PMO films. Films were treated with additional thermal treatments (indicated), and are compared to a 400° C. film kept dry under nitrogen.

FIG. 13 shows the dielectric constant (k) as a function of the organic content (molar fraction F) for PMO films treated with 300° C. calcination+500° C. Films were exposured to an 80% RH environment for periods of 1 d and 5 d, and compared to identical ‘dry’ (unexposed) films; (a) methene, (b) ethene, and (c) 3-ring PMO.

FIG. 14 shows the FTIR spectra for 3-ring PMO films (300° C. calcination+500° C.) of increasing organic content (F values indicated), in comparison to mesoporous silica and a 3-ring xerogel film, after exposure to 80% RH for 1 d.

FIG. 15 shows the change in refractive index (n) of the calcined (300° C.) 3-ring PMO films as a function of the CTACl: [(EtO)₂SiCH₂]₃ molar ratio (R) of the EISA solution.

FIG. 16 shows the change in dielectric constant (k) of the 3-ring PMO films as a function of the CTACl: [(EtO)SiCH₂]₃ molar ratio (R) of the EISA solution, after calcination at 300° C. and additional thermal treatments of 400° C. and 500° C.

FIG. 17 shows indentation force/depth curves for calcined (300° C.) mesoporous silica and PMO films.

FIG. 18 shows the Youngs modulus (E) versus dielectric constant (k) for 3-ring PMO films (A, B, C) as a function of the post-calcination thermal treatments (400° C. and 450° C.).

FIG. 19 shows the PXRD spectrum for a calcined (300° C.) 3 ring/MT₃ film.

FIG. 20 shows the change in dielectric constant (k) with temperature (300° C. calcination+additional thermal treatment) for 3 ring/MT₃ films.

FIG. 21 shows SEM cross-sections of the (a) ethenesilica and (b) dendrisilica xerogel films.

FIG. 22 shows the change in dielectric constant (k) as a function of the thermal treatment temperature for the ethenesilica and dendrisilica xerogel films.

Table 1 shows the Youngs modulus (E) and hardness (H) of calcined films (300° C.) as measured by nanoindentation.

### DETAILED DESCRIPTION OF THE INVENTION

As used herein, “metal oxides” are oxides of all elements except, H, He, C, N, O, F, Ne, S, Cl, Ar, Br, I, At, Kr, Xe, Rn.

As used herein, silicon oxide materials are defined to fall within the class of “metal oxides”.

As used herein, the term “organosilica” means a polysilsesquioxane that contains organic groups.

As used herein, the term “bridging organosilica” or “bridged organosilica” means a polysilsesquioxane that contains bridging organic groups.

As used herein, the term “bridging polysilsesquioxane” or “bridged polysilsesquioxane.” means a polysilsesquioxane that contains bridging organic groups.

As used herein, the term “organosilane” means a silsesquioxane molecule that contains organic groups.

As used herein, the term “bridging organic group” or “bridged organic group” means an organic group, which is bound to at least two metal atoms, such as Si.

As used herein, “organic group” means a group of at least two atoms linked by chemical bonds, which contain at least one covalent carbon hydrogen bond.

As used herein, the term “methene” means a bridging organic group of the type E-(CH₂)-E, where E=element.

As used herein, the term “methenesilica” refers to a bridged organosilica material containing bridged methene groups, of the type Si—(CH₂)—Si.

As used herein, the term “ethene” means a bridging organic group of the type E-(CH₂CH₂)E, where E=element.

As used herein, the term “ethenesilica” refers to a bridged organosilica material containing bridged ethene groups, of the type Si—(CH₂CH₂)—Si.

As used herein, the term “dendrisilica” refers to a bridged organosilica material that contains bridging organic groups in a dendrimeric structure.

As used herein, the term “ring” means a molecule or a building unit of a molecule or a polymer containing one or more cycles of the type EnRn (E=element, R=organic group, n>1).

As used herein, the term “template” or “organic template” means ionic and non-ionic molecules or polymers, supramolecular assemblies of molecules, or particles that have a structure directing function for another molecule or polymer.

As used herein, “surfactant template” means ionic and non-ionic amphiphilic molecules that can self-assemble to have a structure directing function.

As used herein, the term “mesoporous” means having pores with diameter between 2 and 50 nm.

As used herein, the term “periodic mesoporous” means having an ordered arrangement of pores in terms of translation symmetry with a diameter between 2 and 50 nm.

As used herein, the term “macroporous” means having an arrangement of pores with a diameter larger than 50 nm.

As used herein, the term “bridging organosilane” means a silsesquioxane molecule that contains bridging organic groups.

As mentioned above, the present invention overcomes deficiencies in prior art by providing a method for treating a range of metal oxide materials containing bridging organic groups (such as PMOs and non-porous bridged organosilicas) such that they undergo a chemical transformation whereby the bridging organics become terminal groups. To amplify, it is known that the transformation of bridging organic groups into terminal groups occurs in certain bridged organosilicas at specific temperatures beyond those of conventional template removal (calcination) (see Asefa et a/2000). The chemical transformation eliminates polar hydroxyl groups (ie; Si—OH).

When initiated by a thermal treatment, this bridge-terminal chemical transformation can be referred to as a ‘thermal transformation’. After thermal transformation a bridged organosilica film, such as a methenesilica PMO, features a highly porous siloxane (ie; silica) network in which the bridging methene groups have reacted with silanol protons and converted to terminal methyl groups at the surface. This invention only requires a single step thermal treatment, and does not require surface modification through reaction with a gaseous capping species to remove hydrophilic silanol groups. In addition, the thermal transformation does not cause any loss of structural network connectivity. One bridge (organic) is replaced with another (oxygen). Therefore, the ‘transformed’ material containing terminal organic groups does not suffer the same disconnected structural weakness, causing low stiffness and strength, associated with materials synthesized directly from alkyl-terminated precursors (ie; MSSQ).

The present invention involves the treatment of metal oxide materials containing bridging organic groups (such as PMOs) such that they have a very low dielectric constant (k), hydrophobicity and high mechanical strength for applications in microelectronic systems. The transformed materials feature a plurality of terminal organic groups with a molar percentage of Si—C bonds to Si atoms of at least 50 mol %. The organic groups are distributed uniformly throughout the material; in the walls and at the surface of porous frameworks. Finally, practically all hydroxyl groups have been eliminated, to make the material completely resistant to moisture adsorption.

The thermal transformation to eliminate hydroxyl (ie; silanol) groups does not represent a condensation process. This is in stark contrast to the condensation associated with thermal dehydroxylation in purely inorganic silicas and MSSQ, which evolve H₂O. Additionally for bridged organosilicas thermal transformation eliminates practically all the silanol groups at 400-500° C., while in purely inorganic silica many silanol groups remain at those temperatures. The low temperatures at which bridged organosilica materials can be treated is beneficial for a practical application in microelectronics. The “non-condensing” nature of the thermal transformation process also avoids shrinking of the material during thermal curing and consequently appears to enhance cracking-resistance (ie; enhanced thickness cracking threshold) of the films.

PMO materials are bridged polysilsesquioxanes of the form Si—R—Si, where R is an organic group such as methene, ethene, or phenylene, fashioned into a periodic mesoporous structure with pores of highly uniform size. The effective k of bridged organosilica materials is lower than silica by the replacement of Si—O—Si siloxane bridges with less polar Si—R—Si bridges. Asefa et al (2000) reported that thermal treatment at 400-500° C. is sufficient to cause the reaction of the bridging organics with silanol groups in the incompletely condensed structure to transform them to terminal groups.

PMO films can be deposited by dip-coating, spin-coating, ink-jet printing or casting onto a variety of surfaces using an evaporation-induced self-assembly (EISA) method. The porous structure can be a highly-ordered and oriented, or it can be made to be disordered. Alternatively, they could conceivably be deposited by a vapour phase deposition method such as chemical vapour deposition (CVD).

The benefit of this bridge-to-terminal organic group transformation in metal oxide materials containing bridged organic groups (including PMOs) is to simultaneously remove a polar, hydrophilic hydroxyl (ie; silanol) group by reaction with a bridging organic group to produce a terminal organic group. At a surface, this reaction causes that surface to become hydrophobic because it is covered with terminal organic groups. The consequence is that k is lowered due to the transformation, and the material becomes more hydrophobic. It is an advantage for dielectric materials to be highly resistant to moisture adsorption, despite having a high porosity.

Herein, these bridge-terminal chemical transformation properties have been demonstrated to operate by thermal transformation for a range of bridged organic groups in polysilsesquioxane (organosilica) materials, exemplified by (but not limited to) bridged organosilicas with methene (CH₂), ethene (C₂H₄) and 1,3,5-benzene bridges. As a result, these materials develop many properties highly suitable for low-k microelectronics applications. A main advantage is that these materials do not require any post-synthesis vapour treatments (using HMDS vapour, for example) to dehydroxylate the surface, and simply require heating to defined temperatures in an inert atmosphere. As a result, the materials ‘self-hydrophobize’ in situ and simplify the processing stages required in microchip fabrication. It is beneficial to avoid the vapour ‘capping’ treatments necessary for conventional silica and organosilica dielectric films.

Metal oxide materials containing bridged organic groups have much higher mechanical stiffness and strength compared to metal oxides containing only terminal organic groups (such as MSSQ), due to a higher network interconnectivity. Thus, the mechanical properties of PMOs are comparable to mesoporous silica. Since the bridge-terminal transformation replaces an organic bridge with an oxide bridge, there is no loss of network connectivity. As a result, despite a plurality of terminal organic groups, the mechanical properties are sufficiently good to be used in microelectronic applications that require processing such as chemical mechanical polishing (CMP).

Therefore, the application of the bridge-terminal transformation to PMO materials, as an example, is shown to combine uniform pore size, low k (<2.0), high elastic modulus (5-10 GPa), hydrophobicity, thermal stability and relatively simple processing conditions that do not require silanol-capping vapour treatments. These properties make these materials highly suitable for low-k applications, or any application that benefits from a low dielectric constant and hydrophobicity, such as membranes or sensors.

The present invention provides a method of treating a material comprising a metal oxide framework containing organic groups bridging at least two metal atoms, such as Si. Porosity in the material can be structured using a template, but is not restricted to the use of templates. The treatment, such as thermally heating, causes a hydroxyl group-consuming chemical transformation of the organic groups from a bridging to a terminal configuration. More generally, each transformation causes a bridging organic group having n bridging bonds to metal atoms to then have n−1 bridging bonds. A specific non-limiting example could be a bridging 1,3,5-phenyl group which could sequentially thermally transform first to a bridging 1,3-phenyl group and then a terminal phenyl group, while consuming a silanol group at each of these steps. These transformations thereby increase the hydrophobicity of the material in the same order. The metal oxide framework could consist of oxides of silicon, titanium, aluminum, or tin, for example.

The invention will now be illustrated using the following non-limiting methodology.

Evaporation-induced self-assembly (EISA) was used to deposit mesoporous materials rapidly as thin films. An excess of ethanol or butanol, as volatile solvents, was mixed in combination with the organosilane precursor, acid (typically HCl or HNO₃), water and surfactant. The surfactant was typically a cationic alkylammonium, such as cetyltrimethylammonium chloride (CTACl), though a non-ionic surfactant such as C₁₆H₃₃(EO)₁₀H (Brij-56), or a block copolymer such as the triblock (EO)₂₀(PO)₇₀(EO)₂₀ (Pluronic P123) could also be used. The solutions were mixed for a period of 20-60 minutes depending on the rate of organosilane hydrolysis. Once sufficiently hydrolysed, the solutions were clear and found to sufficiently wet the substrates for thin film deposition by spin-coating, dip-coating, printing or casting. Xerogel (non-porous) films were synthesized using EISA solutions without using a surfactant template.

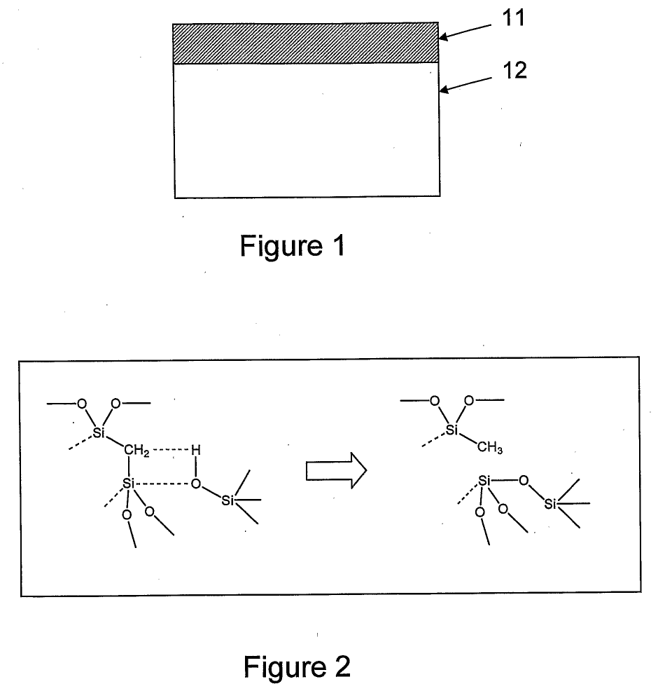

FIG. 1 shows a schematic cross-section of a film (11) situated on a substrate (12). The compositions of the films were controlled by the composition of the EISA solution. Films having different organic contents were made by mixing relative amounts of the silica precursor tetramethylorthosilicate (TMOS, 98% Aldrich) and the organosilane precursor (ie; 3-ring, [(EtO)₂SiCH₂]₃). Also films were synthesized using hybrid combinations of organosilane precursors (ie; 3-ring and MT3).

Films having different porosities were synthesized by controlling the molar ratio (R) of the surfactant to organosilane precursor in the EISA solution, such that a film with a high R ratio would have a high porosity after template removal (to a limit ˜75 vol % upon which the structure typically collapses upon template removal).

The EISA solutions were spin-coated at rates of 1200 to 5000 rpm onto glass or Si wafer substrates for periods of ˜20-30 s to allow the film to form uniformly. The thickness of the films, between 500 to 1500 nm, was controlled by the spin rate, solution viscosity and choice of solvent

The films were dried in air at room temperature or under controlled humidity conditions for 24 h. Calcination was used to remove the surfactant template, though other methods such as solvent extraction could also be used. Calcination involved heating the films to 300° C. at a rate of −1° C./min under flowing nitrogen, and holding for 5 h. The films were typically optically-clear and crack-free following calcination. Further heat treatment was also performed under nitrogen, with holding times of 2 h.

Various characterization methods were used on the films. Powder x-ray diffraction (PXRD) was used to measure the d-spacing and structural phase of the periodic mesostructure of the films. Ellipsometric spectroscopy (ES) was used to measure the refractive index (n) and thickness (t). The dielectric constant (k) was measured using sputtered Au electrode dots (˜0.6 mm²) and the heavily-doped Si substrate as electrodes for measuring the parallel-plate capacitance through the film. The thickness of the film was measured using SEM on fractured cross-sections, or ES. Youngs modulus (E) and hardness (H) were measured using nanoindentation. Fourier transform infra-red spectroscopy (FTIR) was measured in transmission for films deposited on glass substrates.

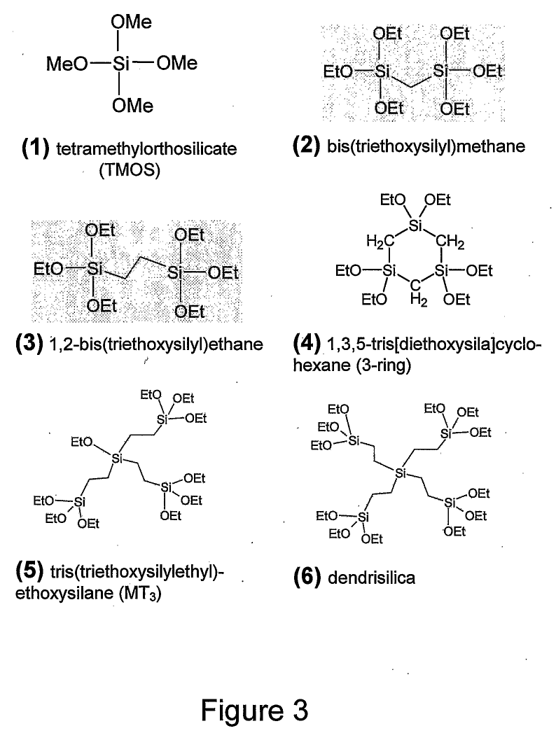

At specific temperatures it has been shown that the bridged organic groups in certain bridged polysilsesquioxanes undergo a chemical reaction with nearby silanol groups to become terminal alkyl groups (ie; bridged methene becomes methyl) as a result of proton transfer, as illustrated in FIG. 2. For methenesilica PMO it has been shown (Asefa et al 2000) that this transformation reaction begins ˜400° C., and progresses until temperatures around 600° C., at which point the terminal methyl groups are lost altogether

Therefore, the present invention provides a method for treating a material comprising a metal oxide framework containing organic groups each bridging at least two metal atoms to increase hydrophobicity and decrease the dielectric constant of said material. The method comprises the step of applying an effective treatment to cause a hydroxyl group-consuming chemical transformation of at least some of said organic groups from a bridging to a terminal configuration, wherein applying said effective treatment increases a hydrophobicity of said material and decreases a dielectric constant of said material.

The present invention also provides a material comprising a metal oxide framework containing organic groups produced by a treatment method comprising the steps of synthesizing a metal oxide framework containing organic groups bridging at least two metal atoms, and applying an effective treatment to cause a hydroxyl group-consuming chemical transformation of at least some of said organic groups from bridging to a terminal configuration. The chemical transformation causes the organic groups to be in a configuration of being attached to at least one less metal atom.

The chemically-transformed materials have a low dielectric constant, a hydrophobic resistance to moisture adsorption and a high Youngs modulus. The materials produced in this way may have a dielectric constant in the range of about 1.1 to about 3.0, or more preferably from about 1.6 to about 2.2. The metal oxide framework may be porous (with or without the use of a template) or non-porous.

The present invention also provides a material comprising a metal oxide framework containing uniformly-distributed terminal organic groups, following a bridge-terminal chemical transformation. There is a highly uniform distribution of organic groups. In a porous material the organic groups are uniformly distributed within the pore walls, in addition to the surface of the walls. The material has a ratio of the total number of Si—C bonds to the total number of Si atoms of at least 50 mole percent. There are substantially no hydroxyl groups, due to the bridge-terminal transformation reaction, and the material has a hydrophobic resistance to moisture adsorption. The material provided has a dielectric constant in the range of about 1.1 to about 3.0, or more preferably from about 1.6 to about 2.2. The material has a Youngs modulus of at least 3 GPa. The metal oxide framework may be porous (with or without the use of a template) or non-porous.

The bridging organic group may be an alkylene group, an alkenylene group, alkynylene, phenylene group, hydrocarbons containing a phenylene group, or other organic groups derived from compounds having at least one carbon atom.

The metal atoms may be silicon, germanium, titanium, aluminum, indium, zirconium, tantalum, niobium, tin, hafnium, magnesium, molybdenum, cobalt, nickel, gallium, beryllium, yttrium, lanthanum, lead and vanadium.

The material may be structured by an organic template wherein the organic template is selected from the group consisting of labile organic groups, solvents, thermally decomposable polymers, small molecules, cationic surfactants, anionic surfactants, non-ionic surfactants, dendrimers, hyper branched polymers, block copolymers, polyoxyalkylene compounds, colloidal polymeric particles, and combinations thereof.

The material structure may be mesoporous with a mean pore diameter in the range from about 1 to about 50 nm, or, the material structure may be macroporous with a mean pore diameter at least 50 nm. The material may have a periodic arrangement of pores and a mean pore spacing of at least 2 nm.

The porous structure of the material may have a periodic unit cell symmetry consisting of a 2-dimensional hexagonal structure, a 3-dimensional hexagonal structure, a cubic structure, and a lamellar structure, or, the film may have a non-periodic arrangement of pores. The material may have a porous volume in the range from about 0 to about 90 vol %. The film morphology may have a continuous layer or collection of particles aggregated into a layer. The film may be deposited by spin-coating, dip-coating, printing or casting, and the film may have a thickness is at least 10 nm. Alternatively, a vapour phase deposition, such as chemical vapour deposition (CVD) could conceivably be used.

The chemical transformation may be a thermal transformation that involves heating to at least 200° C. for an effective period of time to affect said thermal transformation. The atmosphere of the thermal treatment may be any one or combination of nitrogen, helium, neon, argon, krypton, xenon, carbon dioxide and oxygen. Alternatively, other methods of treatment to cause the hydroxyl-consuming, bridge-terminal transformation of the organic groups, such as optical, electrical, chemical or thermal means, including but not limited to UV-curing, or oxidizing plasma treatment could conceivably be used.

In a preferred embodiment the material has a Youngs modulus of at least 6 GPa when the dielectric constant is 1.80. A semiconductor device may be produced comprising at least one dielectric insulating layer wherein the at least one dielectric insulating layer comprises a porous film produced above.

By way of example, non-limiting examples are presented here for methene, ethene, 3-ring, and 3-ring/MT₃ hybrid PMO films, and non-porous bridged organosilica xerogel films, synthesized using evaporation-induced self-assembly.

### EXAMPLE 1

### Methene PMO

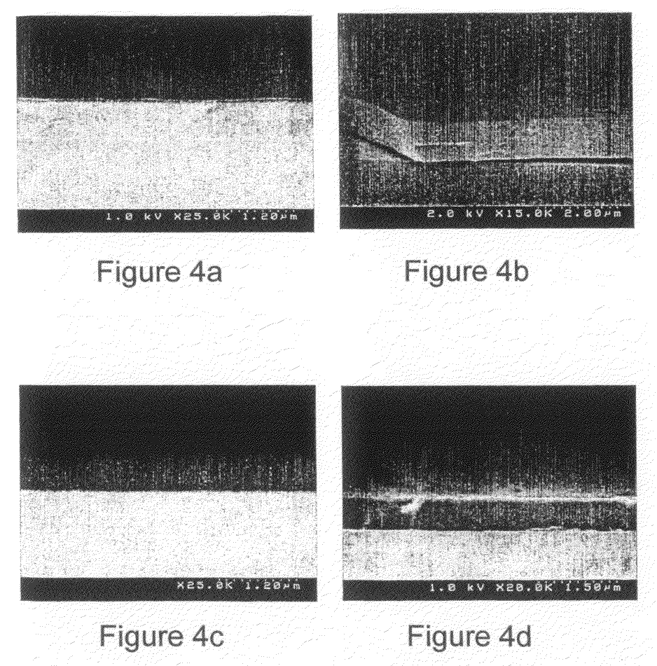

Methene PMO films were synthesized using the (EtO)₃S₁—CH₂—Si(EtO)₃ (Gelest, 98%) organosilane precursor (2 in FIG. 3) (see Hatton et al 2005). A typical synthesis would involve mixing 0.356 g of 10⁻³M HCl, 1.135 g EtOH, and 0.450 g aqueous cetyltrimethylammonium chloride (CTACl) solution (25 wt. %, Aldrich) to make a homogeneous solution, then adding 0.419 g of (EtO)₃S₁—CH₂—Si(EtO)₃ (molar ratio 1.0:31.3:2.89×10⁻⁴:10:0.285 of (EtO)₃S₁—CH₂—Si(EtO)₃:H₂O:HCl:EtOH:CTACl). Films were spin-coated on Si wafer at speeds of 2000 to 4000 rpm, then calcined at 300° C. under nitrogen (1° C./min ramp, 5 h hold). Following calcination, various additional thermal treatments were applied under nitrogen for 2 h.

Films with varying organic content were synthesized using mixtures of the silica (TMOS, 1 in FIG. 3) and the silsesquioxane precursor, defined by the molar ratio, F. Since these PMOs contain T-sites for Si, where T_{1,2,3} corresponds to RSi(OSi)ₓ(OH)₃₋ₓ tetrahedral sites, F_{T} is defined by,

$${F}_{T} = \frac{\frac{1}{2} ( {n}_{PMO} )}{\frac{1}{2} ( {n}_{PMO} ) + {n}_{TMOS}} \qquad [ 1 ]$$

where x(n_{TMOS})+(1-x){1/2(n_{PMO})}=1.0. Thus, precursors TMOS and (EtO)₃SiCH₂Si(OEt)₃ were mixed, for molar fractions of the Si sites F_{T}=T: (T+Q)=0, 0.25, 0.5, 0.75, and 1.

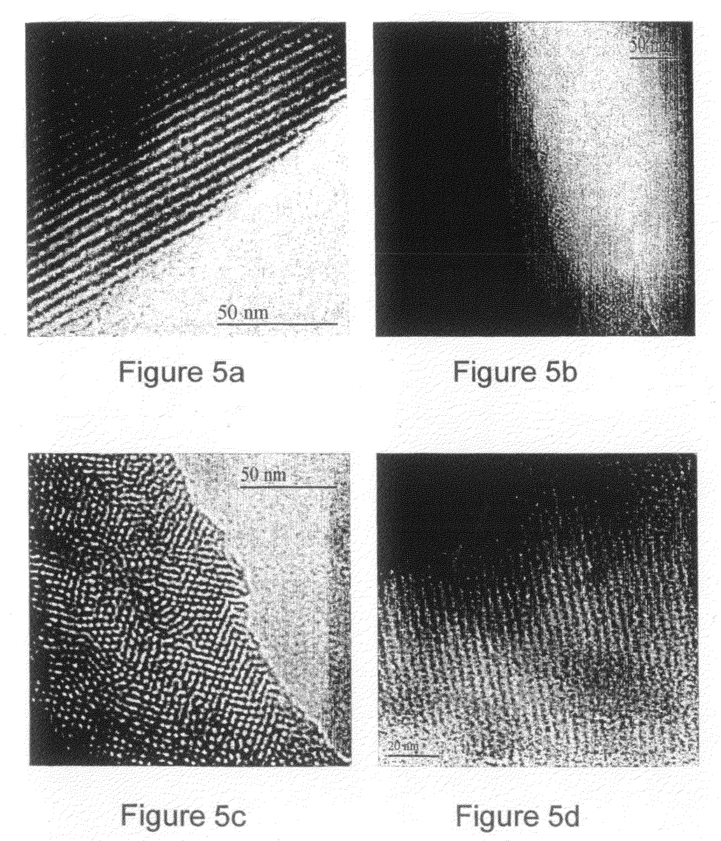

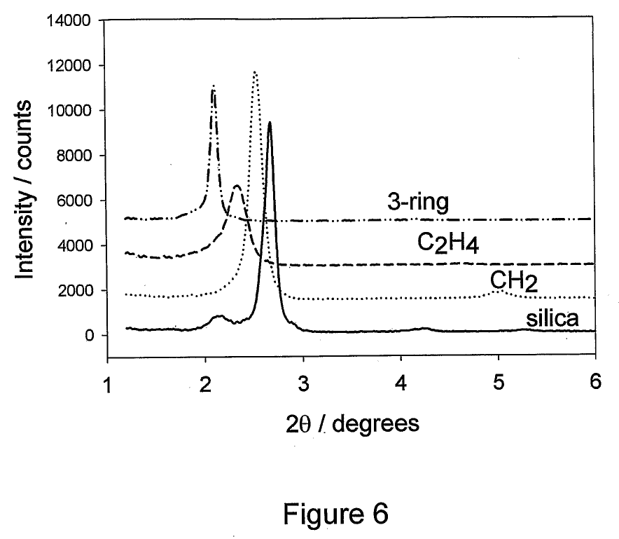

FIG. 4a shows a methene PMO film in cross-section, on a Si substrate. The films had uniform thickness, were crack-free and adherent to the substrate. FIG. 5b shows a transmission electron microscope (TEM) image of the calcined film, compared to mesoporous silica (FIG. 5a) and the other PMO films, indicating the high degree of order of the 2D hexagonal (p6 mm) phase.

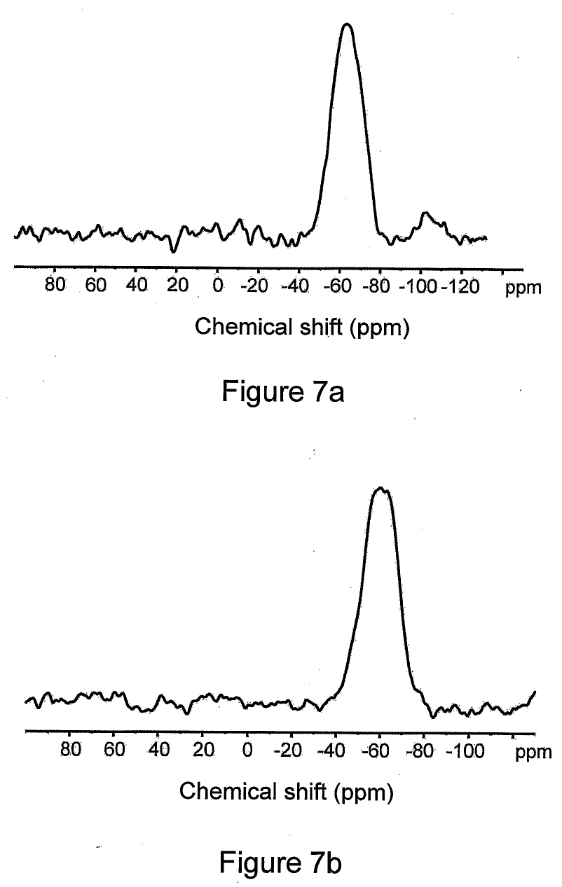

FIG. 6 shows a PXRD spectrum of the calcined (300° C.) methene PMO compared to mesoporous silica and the other PMO films. The strong sharp peaks indicate a high degree of order, and the peak shift corresponds to the change in d-spacing with the size of the silsesquioxane precursors.

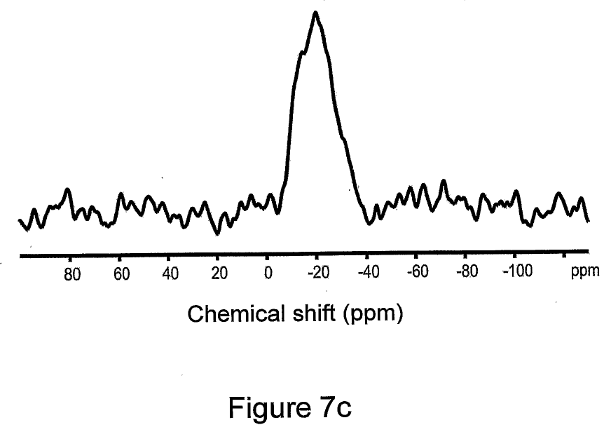

The ²⁹Si MAS NMR spectrum is illustrated in FIG. 7a for the calcined methenesilica material. The ²⁹Si spectrum indicates a signal for a chemical shift typical for Tₓ sites (CH₂)Si(OSi)ₓ(OH)₃₋ₓ with maxima around −63 ppm, and a small signal around −100 pm for some Qₓ sites, defined as Si(OSi)ₓ(OH)ₓ. This indicates that the calcination conditions contribute only very minor Si—C bond cleavage, such that the bridging groups remain intact.

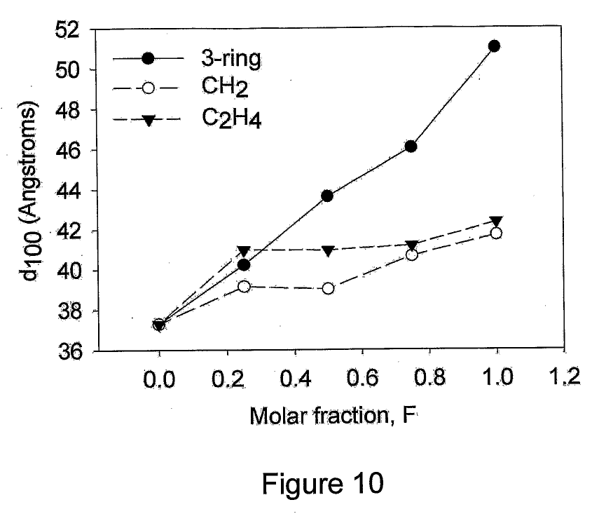

For those films synthesized with a combination of silica and (EtO)₃SiCH₂Si(OEt)₃, FIG. 10 (open circles) shows that the d-spacing shifts linearly with the molar fraction, F. Therefore there is homogeneous mixing of the precursors (as for the ethene and 3-ring PMO films having increasing organic content).

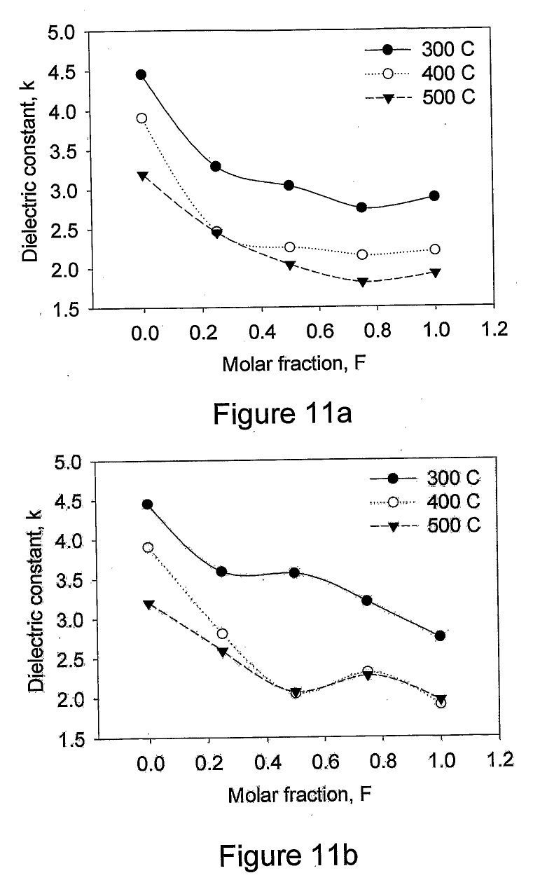

The dielectric constant (k) as a function of the organic content (molar fraction F) is shown in FIG. 11a. The results are shown as a function of the heat treatment temperature. Values of k decrease with increasing organic content, and are lowest for those compositions synthesized entirely from the silsesquioxane precursor (ie; F=1.0). There is a further decrease in k after heat treatment at 400° C., which is a consequence of the silanol elimination associated with the bridge-terminal transformation. The values of k decrease slightly further, after heat treatment at 500° C. Further heating to 600° C. causes k to increase dramatically, as expected once the organic groups are lost altogether, leaving behind a hydrophilic surface of silanol groups.

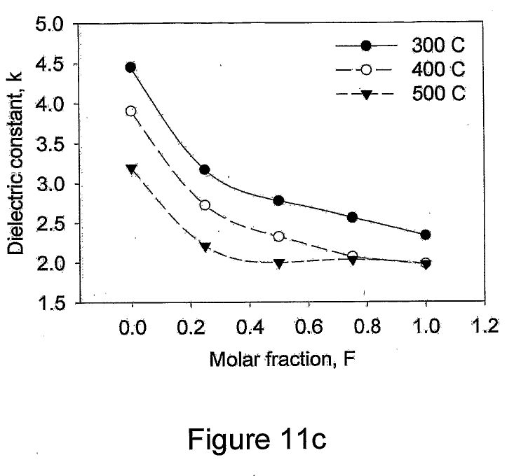

The effects of exposure to humid environments are illustrated in FIG. 12 for the methene PMO, as a function of the thermal treatments. The measure values of k are plotted versus the molar fraction F for films having heat treatments of 400° C., 450° C. and 500° C. exposed to an environment of 80% relative humidity (RH) for a period of 1 d. They are compared to a 400° C. film, which has been maintained in a moisture-free N₂ glove box (labelled as ‘dry’). Clearly there is a dramatic increase in k for those films having F<1.0, and a smaller increase for having heat treatments less than 500° C. Values of k increase significantly because of water adsorbed on the surface, which is highly polar and has k ˜80. The thermal treatments are beneficial for hydrophobicity at 400° C. and 450° C., but are completely effective by 500° C. This result clearly indicates the beneficial effects of the organic content and the thermal transformation on the hydrophobicity and resistance to moisture adsorption.

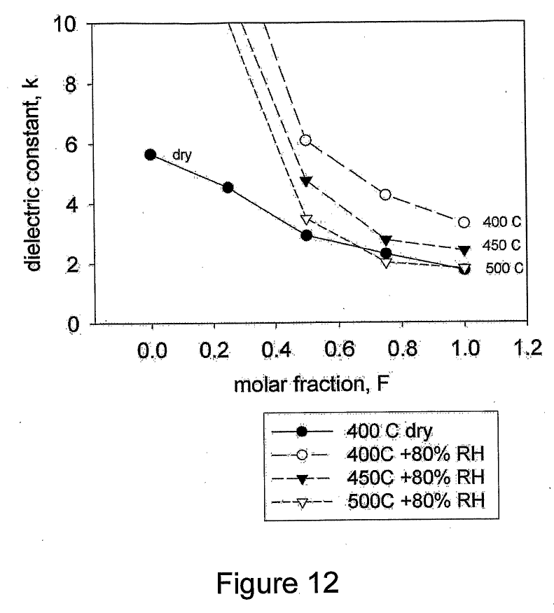

The effects of exposure to humid environments are also illustrated in FIG. 13a for calcined+500° C. methene PMO films; dry (stored in a moisture-free glove box), and exposed to an 80% RH environment for periods of 1 d and 5 d. Clearly there is a dramatic increase in k for those films having F <1.0. Values of k increase significantly because of water adsorbed on the surface, which is highly polar and has k ˜80. For those films with F=1.0 there is no change in k, even after 5 d. This result clearly indicates the beneficial effects of the organic content and the thermal transformation treatment on the hydrophobicity and resistance to moisture adsorption.

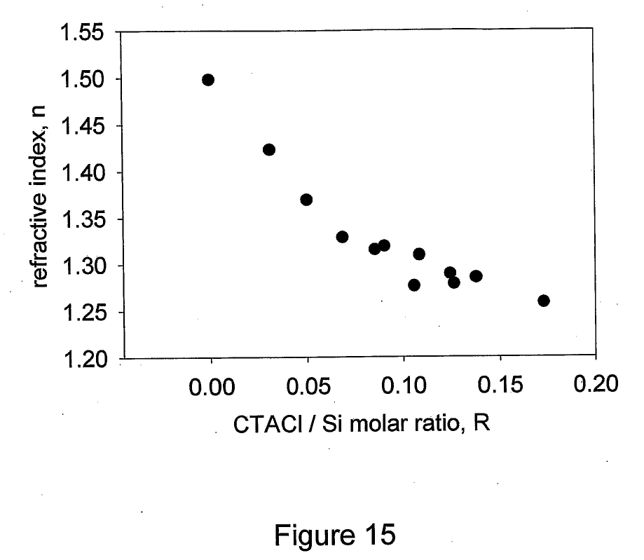

A nanoindentation force-depth indentation curve for a calcined (300° C.) methene PMO film (compared to silica and the other PMOs of the same porosity) is shown in FIG. 17. The averaged results for E and H compared to mesoporous silica are shown in Table 1. Both E and H are increased (12.7 GPa and 0.51 GPa, respectively) compared to silica (10.0 GPa and 0.44 GPa).

Therefore, methene PMO films treated to 300° C. calcination, plus additional thermal treatments (400-500° C.) in an inert atmosphere show a bridge-terminal chemical transformation that causes a lower k, and increased hydrophobicity. The films are completely resistant to moisture adsorption after 500° C. treatment.

### EXAMPLE 2

### Ethene PMO

Ethene PMO films were synthesized using the (EtO)₃S₁—CH₂CH₂—Si(EtO)₃ (Aldrich, 96%) organosilane precursor (3 in FIG. 3). A typical synthesis involved mixing 0.356 g of 10⁻³M HCl, 0.5675 g EtOH, and 0.450 g aqueous cetyltrimethylammonium chloride (CTACl) solution (25 wt. %, Aldrich) to make a homogeneous solution, then adding 0.437 g of (EtO)₃SiCH₂CH₂Si(OEt)₃ (molar ratio 1.0:31.3:2.89×10⁻⁴:5:0.285 of (EtO)₃SiCH₂CH₂Si(OEt)₃:H₂O:HCl:EtOH:CTACl).

As for example 1; films with varying organic content were synthesized using mixtures of TMOS and the silsesquioxane precursors. Thus, precursors TMOS and (EtO)₃SiCH₂CH₂Si(OEt)₃ were mixed for molar fractions of the Si sites F_{T}=T: (T+Q)=0, 0.25, 0.5, 0.75, and 1 (according to equation 1). Films were spin-coated on Si wafer at speeds of 2000 to 4000 rpm, then calcined at 300° C. under nitrogen (1° C./min ramp, 5 h hold). Following calcination, various additional thermal treatments were applied under nitrogen for 2 h.

FIG. 4b shows an ethene PMO film in cross-section, on a Si substrate. The films had uniform thickness, were crack-free and adherent to the substrate. FIG. 5c shows a transmission electron microscope (TEM) image of the calcined film, and FIG. 6 shows a PXRD spectrum of the calcined (300° C.) ethene PMO, compared to mesoporous silica and the other PMO films. The strong sharp peaks indicate a high degree of order, with the channels oriented parallel to the substrate surface.

The ²⁹Si MAS NMR spectrum is illustrated in FIG. 7b for the calcined ethenesilica material. The ²⁹Si spectrum indicates a signal for a chemical shift typical for Tₓ sites (CH₂)Si(OSi)ₓ(OH)₃₋ₓ with maxima around 60 ppm, and no sign of a peak around −100 pm for Qₓ sites (Si(OSi)ₓ(OH)x). Therefore, the bridging groups (ie; Si—C bonds) remain intact after the 300° C. calcination.

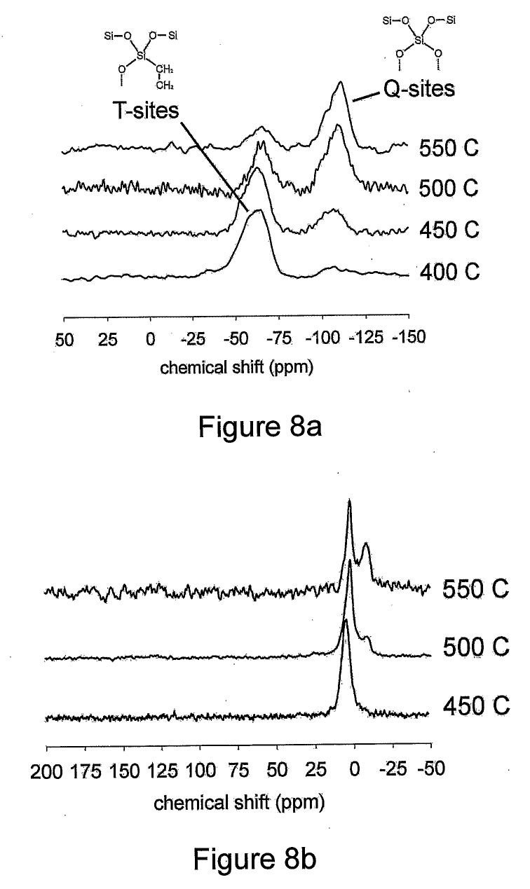

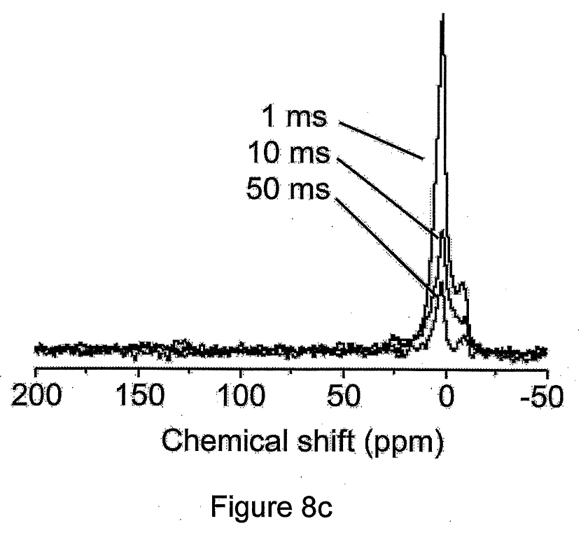

FIG. 8 demonstrates that the bridge-terminal thermal transformation also occurs for bridging ethene groups. FIGS. 8a and 8b show the ²⁹Si and ¹³C MAS NMR spectra, respectively, for the ethene PMO films as a function of temperature. The ²⁹Si spectra show the transition of T-sites into Q-sites beginning at 400° C. The ¹³C spectra show that the organics are not lost, but experience a bridge-terminal transformation, as for the methene groups. The peak at 4.6 ppm (for S₁—CH₂CH₂—Si) splits into two distinct peaks 1.9 and −2.8 ppm by 500° C. and 550° C., corresponding to the two carbon sites in the (bridging) CH₂ and (terminal) CH₃ groups.

FIG. 8c further corroborates the transformation reaction. A series of ¹³C NQS experiments taken for samples treated at 500° C. at three delay times of d3=1 μs, 10 μs, and 50 μs are shown. The remaining peak at 2.0 ppm for the spectra with d=50 μs clearly demonstrates the presence of a terminal CH₃ group, and not a bridging CH₂ group.

For those films synthesized with a combination of silica and (EtO)₃Si CH₂CH₂Si(OEt)₃, FIG. 10 (triangles) shows that the d-spacing shifts linearly with the molar fraction, F. Therefore there is homogeneous mixing of the precursors (as for the methene and 3-ring PMO films having increasing organic content).

The dielectric constant (k) as a function of the organic content (molar fraction, F) is shown in FIG. 11b, as a function of the treatment temperature. As for the methene PMO, k decreases with increasing organic content, and are lowest for F=1.0. There is a further decrease in k after heat treatment at 400° C. and 500° C., which is a consequence of the silanol elimination associated with the bridge-terminal transformation. Further heating to 600° C. causes k to increase dramatically, as expected once the organic groups are lost altogether, which leaves behind a hydrophilic surface of silanol groups.

The effects of exposure to humid environments are illustrated in FIG. 13b for ethene PMO films calcined (300° C.) and thermally treated at 500° C.; dry (stored in a moisture-free glove box), and exposed to an 80% RH environment for periods of 1 d and 5 d. Clearly there is a dramatic increase in k due to adsorbed water (since X_{H2O} ˜80) for those films having F<0.5, and a small increase for those films with F of 0.5 and higher. Therefore, the thermally-transformed (500° C.) ethene PMO films show a very high hydrophobic resistance to moisture adsorption, but slightly less than the methene and 3-ring PMO materials.

A nanoindentation force-depth indentation curve for a calcined (300° C.) ethenesilica PMO film (compared to silica and the other PMOs) is shown in FIG. 17. The averaged results for E and H compared to mesoporous silica are shown in Table 1. Both E and H are increased (13.3 GPa and 0.77 GPa, respectively) compared to silica (10.0 GPa and 0.44 GPa).

Therefore, ethene PMO films treated to 300° C. calcination, plus additional thermal treatments (400-500° C.) in an inert atmosphere show a bridge-terminal chemical transformation that causes a lower k, and increased hydrophobicity. The bridge-terminal transformation of ethene bridges is demonstrated for the first time.

### EXAMPLE 3

### 3-Ring PMO

Films of the 3-ring PMO were synthesized using the cyclic 3-ring [(EtO)₂SiCH₂]₃ organosilane precursor (4 in FIG. 3) (see Landskron et al 2003). A typical synthesis involved mixing 0.356 g of 10⁻³M HCl, 0.568 g EtOH, and 0.450 g aqueous cetyltrimethylammonium chloride (CTACl) solution (25 wt. %, Aldrich) to make a homogeneous solution, then adding 0.488 g of [(EtO)₂SiCH₂]₃ (molar ratio 1.0:31.3:2.89×10⁻⁴:10:0.285 of [(EtO)₂SiCH₂]₃:H₂O:HCl:EtOH:CTACl). Films were spin-coated on Si wafer at speeds of 2000 to 4000 rpm, then calcined at 300° C. under nitrogen (1° C./min ramp, 5 h hold). Following calcination, various additional thermal treatments were applied under nitrogen for 2 h.

Films with varying organic content were synthesized using mixtures of TMOS and [(EtO)₂SiCH₂]₃, according to the molar ratio, F_{D}. Since these PMOs contain D-sites for Si, where D_{1,2,3} corresponds to (CH₂)₂Si(OSi)ₓ(OH)₂₋ₓ tetrahedral sites, F_{D} is defined by,

$${F}_{D} = \frac{\frac{1}{3} ( {n}_{ring} )}{\frac{1}{3} ( {n}_{ring} ) + {n}_{TMOS}} \qquad [ 2 ]$$

where x(n_{TMOS})+(1-x){1/3(n_{ring})}=1.0. Thus, precursors TMOS and [(EtO)₂SiCH₂]₃ were mixed, for molar fractions of the Si sites F_{D}=D: (D+Q)=0, 0.25, 0.5, 0.75 and 1.

FIG. 4c shows a 3-ring PMO film in cross-section, on a Si substrate. The films had uniform thickness, were crack-free and adherent to the substrate. FIG. 5d shows a transmission electron microscope (TEM) image of the calcined (300° C.) film, compared to mesoporous silica (FIG. 5a) and the other PMOs, indicating the high degree of order of the 2D hexagonal (p6 mm) phase.

FIG. 6 shows a PXRD spectrum of the calcined (300° C.) 3-ring PMO compared to mesoporous silica and the other PMOs. The strong sharp peaks indicate a high degree of order, and the peak shift corresponds to the change in d-spacing with the size of the silsesquioxane precursors.

The ²⁹Si spectrum for the calcined (300° C.) 3-ring PMO is shown in FIG. 7b, which shows a broadened signal at −20 ppm attributed to a convolution of D₁ (CH₂)₂Si(OSi)(OH) and D₂ (CH₂)₂Si(OSi)₂ sites, proving that all Si—C bonds remained intact at this temperature.

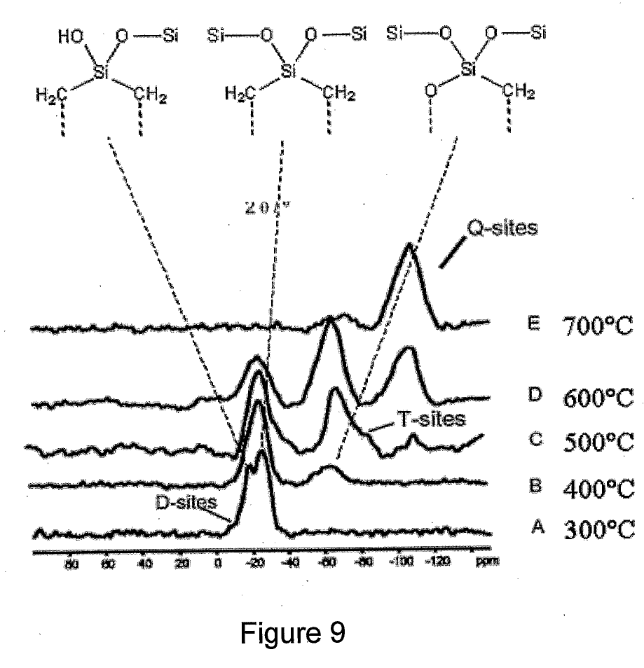

FIG. 9 illustrates the change in the ²⁹Si MAS NMR spectra as a function of temperature for the 3-ring PMO. The D sites ((CH₂)₂Si(OSi)ₓ(OH)₂₋ₓ) of the ‘intact’ bridged structure (calcined at 300° C.) begin to transform into T sites (CH₂Si(OSi)ₓ(OH)₃₋ₓ) at 400° C. The appearance of T sites indicates that some bridging groups have become terminal groups, consuming a silanol group in the process. At 500° C. there is a combination of D and T sites. By 600° C. there is also a peak ˜100 ppm which represents Q sites ((Si(OSi)ₓ(OH)₄×), and which indicates a complete loss of the organic groups.

For those films synthesized with a combination of silica and [(EtO)₂SiCH₂]₃, FIG. 10 (solid circles) shows that the d-spacing shifts linearly with the molar fraction, F. Therefore there is homogeneous mixing of the precursors (as for the methene and ethene PMO films having increasing organic content).

The dielectric constant (k) as a function of the organic content (as measured by the molar fraction F) is shown in FIG. 11c. The results are shown as a function of the heat treatment temperature. Values of k decrease with increasing organic content, and are lowest for those compositions synthesized entirely from the silsesquioxane precursors (ie; F=1.0) for each of the PMO materials. There is a further decrease in k after heat treatment at 400° C., which is a consequence of the silanol elimination associated with the bridge-terminal transformation. The values of k decrease slightly further after heat treatment at 500° C., for F<0.75. At F=0.75 and 1.0, thermal treatment at 400° C. and 500° C. yields similar results for k. Further heating to 600° C. causes k to increase dramatically, as expected once the organic groups are lost altogether, leaving behind a hydrophilic surface of silanol groups.

The effects of exposure to humid environments are illustrated in FIG. 13c for calcined+500° C. 3-ring PMO films; dry (stored in a moisture-free glove box), and exposed to an 80% RH environment for periods of 1 d and 5 d. Clearly there is a dramatic increase in k for those films having F<0.5 due to adsorbed water (since k_{H2O} ˜80). For those films with F=0.75 and 1.0 there is no change in k, even after 5 d. This result clearly indicates the beneficial effects of the organic content and the thermal transformation treatment on the hydrophobicity and resistance to moisture adsorption.

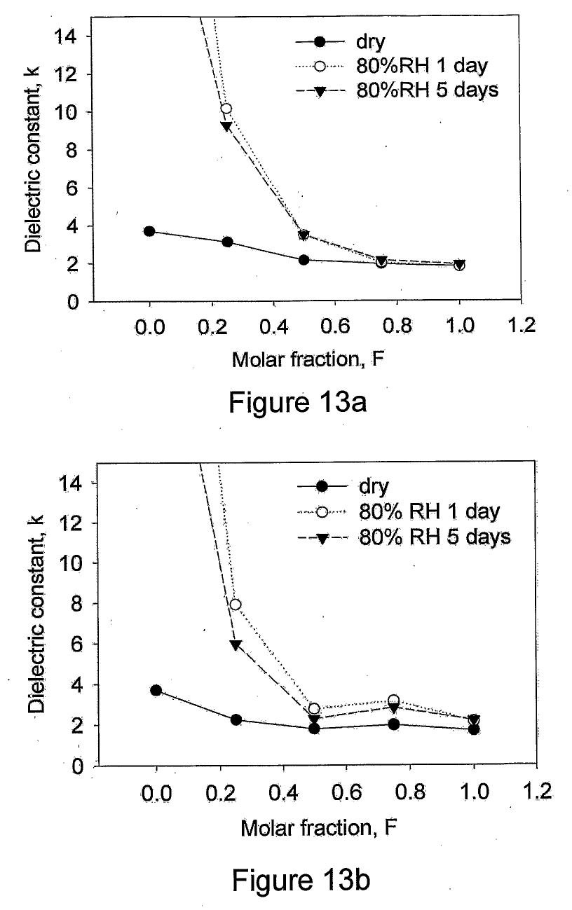

FIG. 14 shows FTIR spectra for 3-ring PMO films (500° C.) of increasing organic content (F values indicated), in comparison to mesoporous silica and a 3-ring xerogel film (no template), after exposure to 80% RH for 1 d. The peaks at ˜2960 cm⁻¹ correspond to the C—H stretching of the bridging methene groups. There is a substantial peak for the silica film at ˜3400 cm⁻¹ corresponding to the O—H stretching of —OH groups and physisorbed, surface-bound water. The peak intensity decreases dramatically with increasing organic content and disappears completely for the F=1.0 PMO and xerogel films, indicating the films are very hydrophobic and are not absorbing any moisture.

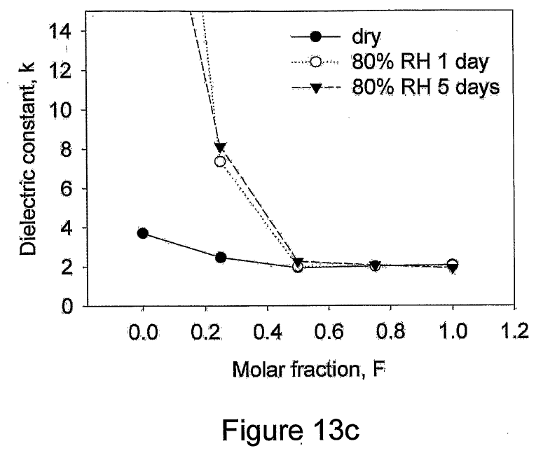

Films of the 3-ring PMO having a range of porosity were synthesized using increasing molar ratios of R=CTACl/[(EtO)₂SiCH₂]₃ (R=0 indicates a xerogel film). FIG. 15 shows the decrease in refractive index (n) after calcination with increasing R which indicates the increasing porosity with increasing volume fraction of surfactant.

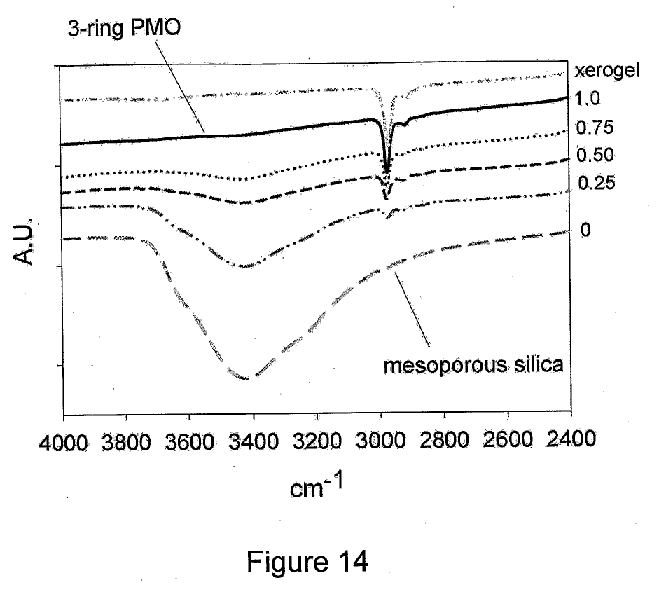

FIG. 16 shows the change in k with increasing R after calcination at 300° C. and subsequent heat treatments of 400° C. and 500° C. (same film samples). The increase in porosity with R causes a continuous decrease in k, since for air k ˜1.0. The ‘intact’ 300° C. films decrease from ˜3.6 (R=j) to ˜2.1. Heat treatment at 400° C. and 500° C. causes k to decrease further, due to the thermal transformation shown above. At 500° C. the lowest values of k are 1.70 in the range R=0.14 to 0.17.

A nanoindentation force-depth indentation curve for a calcined (300° C.) 3-ring PMO film (compared to silica and the other PMOs) is shown in FIG. 17. The averaged results for E and H compared to mesoporous silica are shown in Table 1. Both E and H are increased (11.8 GPa and 0.67 GPa, respectively) compared to silica (10.0 GPa and 0.44 GPa) of the same porosity.

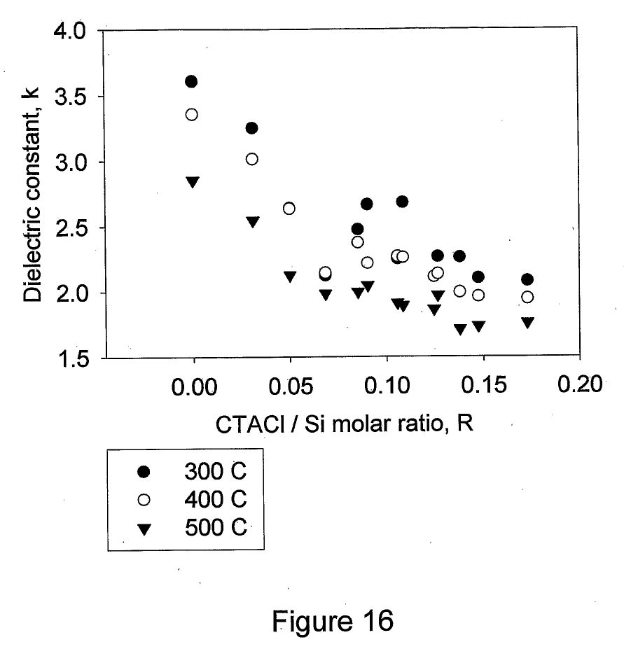

FIG. 18 shows the Youngs modulus (E) versus dielectric constant (k) for a series of three 3-ring PMO films (A, B, C) synthesized using Brij-56 surfactant, with different surfactant/precursor molar ratios (to increase the porosity, A being the lowest). The results are shown as a function of the post-calcination thermal treatments (400° C. and 450° C.). There is a decrease in both E and k with increasing porosity, but thermal treatment at 450° C. improves the ratio of E/k for all films tested. After 450° C. treatment Film B has k=−1.80 and E=7.26 GPa.

Therefore, 3-ring PMO and non-porous xerogel films treated to 300° C. calcination, plus additional thermal treatments (400-500° C.) in an inert atmosphere show a bridge-terminal chemical transformation that causes a lower k, and increased hydrophobicity. Films have been synthesized to have k=1.80, E=7.2 GPa, and complete resistance to moisture adsorption after exposure at 80% RH for 5 d.

### EXAMPLE 4

### 3Ring/MT₃ PMO

Hybrid films were synthesized with a combination of 40 mol % 3-ring precursor (4 in FIG. 3) and 60 mol % MT₃ precursor (5 in FIG. 3). A typical synthesis involved mixing 0.356 g of 10⁻³M HCl, 0.568 g EtOH, and 0.400 g aqueous cetyltrimethylammonium chloride (CTACl) solution (25 wt. %, Aldrich) to make a homogeneous solution, then adding a mixed solution of 0.293 g of the 3-ring and 0.259 g of the MT₃ precursors (molar ratio 1.0:0.498:54.0:4.43×10⁻⁴:15.3:0.389 of 3 ring:MT₃:H₂O:HCl:EtOH:CTACl). Films were spin-coated on Si wafer at speeds of 2000 to 4000 rpm, then calcined at 300° C. under nitrogen (1° C./min ramp, 5 h hold). Following calcination, various additional thermal treatments were applied under nitrogen for 2 h.

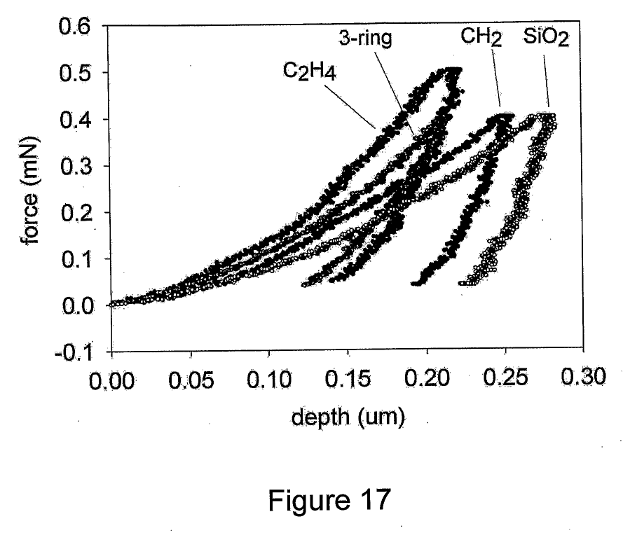

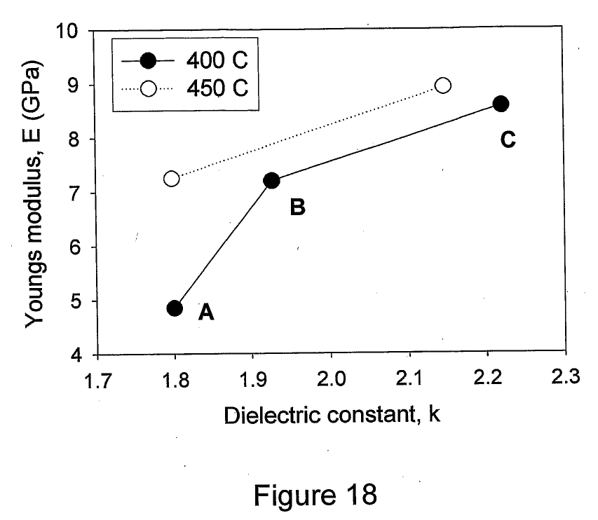

FIG. 4d shows an SEM cross-section of a calcined (300° C.) film, and FIG. 19 shows a PXRD pattern for the same film, showing a clear peak corresponding to a d-spacing of 4.2 nm, indicating an ordered hexagonal mesostructure. FIG. 20 shows preliminary measurements of the dielectric constant k, as a function of thermal treatment temperatures, from calcination (300° C.) to 400° C. and 500° C. Clearly, k decreases with temperature, from 2.51 (300° C.) to 2.21 (500° C.), demonstrating an effective thermal transformation behaviour. Nanoindentation measurements of the 300° C. film show E=14.07 GPa and H=1.51 GPa. Increasing the porosity is expected to reduce k further, but maintain a high E/k ratio.

Therefore, the effects of thermal transformation on lowering the dielectric constant of a hybrid PMO comprising a combination of 3-ring and MT₃ precursors are demonstrated.

### EXAMPLE 5

### Bridged Organosilica Xerogel Films

Organosilica xerogel films, using no organic template, were synthesized using the ethene (3 in FIG. 3) and the dendrisilica precursor (6 in FIG. 3). A typical synthesis involved mixing 0.360 g of 0.10 M HCl, and 0.500 g EtOH to make a homogeneous solution, then adding 0.443 g of the ethene precursor (molar ratio 1.0:16.0:0.0288:8.70 of ethene:H₂O:HCl:EtOH), or 0.397 g of the dendrisilica precursor (molar ratio 1.0:40.0:0.0719:21.7 of dendrisilica:H₂O:HCl:EtOH), respectively. Films were spin-coated on Si wafer at speeds of 2000 to 4000 rpm, then calcined at 300° C. under nitrogen (1° C./min ramp, 5 h hold). Following calcination, various additional thermal treatments were applied under nitrogen for 2 h.

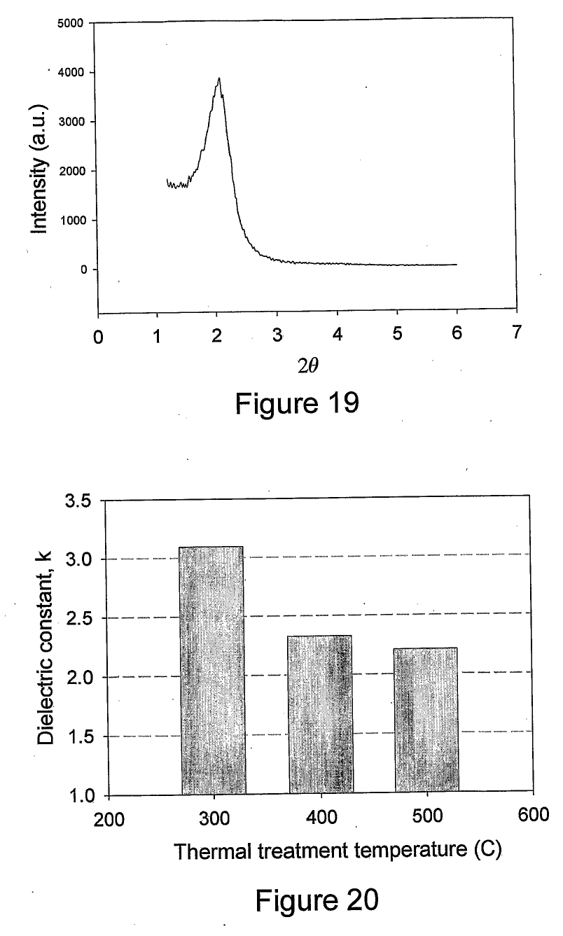

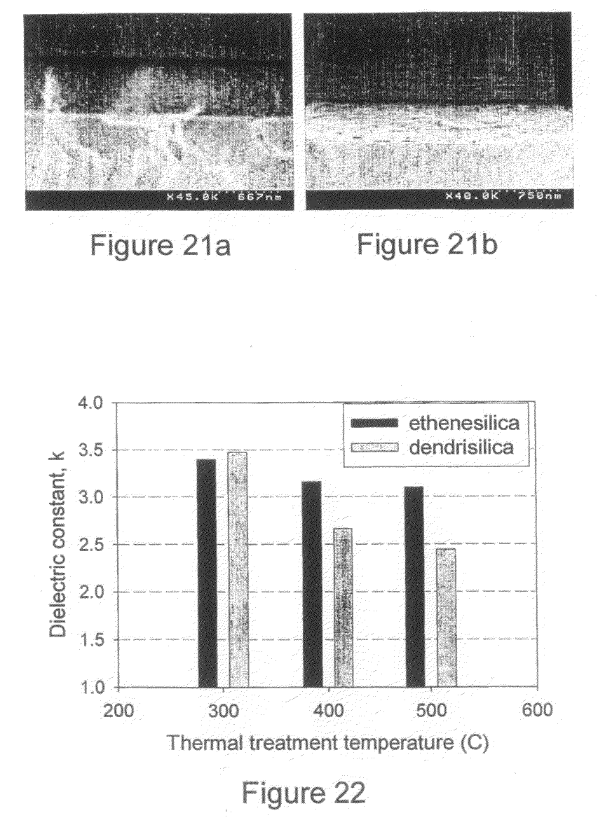

FIGS. 21a and 21b show SEM cross-sections of the ethenesilica and dendrisilica xerogel films. FIG. 22 shows the change in dielectric constant (k) as a function of the thermal treatment temperature. The ethenesilica decreases from 3.40 (300° C. film) to 3.10 (500° C. film), and the dendrisilica decreases from 3.47 (300° C. film) to 2.44 (500° C. film). As a result, there is a pronounced effect of the thermal treatment on k for these non-porous bridged organosilica films.

Therefore, the effects of thermal transformation on lowering the dielectric constant of two non-porous bridged organosilica xerogel films containing methene and ethene groups, respectively are demonstrated. The dendrisilica material has a higher organic content than the ethenesilica material, and shows a bigger effect of the thermal treatment.

### Instrumentation

PXRD patterns were measured with a Siemens D5000 diffractometer (λ=0.1542 nm).

All solid state NMR experiments were performed with a Bruker DSX 400 NMR spectrometer. ²⁹Si MAS-NMR spectra were recorded at a spin rate of 5 kHz and a pulse delay of 5 s. ¹³C CP MAS-NMR experiments were performed at a spin rate of 5 kHz, a contact time of 5 ms and a pulse delay of 3 s.

TEM images were recorded on a Philips Tecna±20 microscope at an accelerating voltage of 200 kV (film fragments on C film-coated Cu grids). SEM images were recorded with an Hitachi S-4500 microscope operating at 1 kV.

Nanoindentation of the films was used to measure mechanical properties (Shimadzu DUH-2100) with a Berkovich diamond indenter at loads from 0.1-10 mN. For each measurement, 4 load/unload cycles were used with a 5 second holding time.

Dielectric constants were determined from parallel-plate capacitance measurements using a 1 MHz 4280A Hewlett-Packard C meter at 30 mV amplitude (and 0 bias) on films deposited onto heavily-doped Si (100) wafers. Au dots of ˜0.6 mm² (sputtered through a shadow mask) were the top electrodes, and a minimum of 6 electrodes, were measured for each sample.

Refractive index measurements were made using a Sopra GES-5 ellipsometer spectrometer over a range 300-1300 nm.

FTIR (Perkin Elmer Spectrum GX) was used to characterize the vibrational absorption spectra of films deposited on glass slides, in transmission from 4000-2000 cm⁻¹.

As used herein, the terms “comprises”, “comprising”, “including” and “includes” are to be construed as being inclusive and open ended, and not exclusive. Specifically, when used in this specification including claims, the terms “comprises”, “comprising”, “including” and “includes” and variations thereof mean the specified features, steps or components are included. These terms are not to be interpreted to exclude the presence of other features, steps or components.

The foregoing description of the preferred embodiments of the invention has been presented to illustrate the principles of the invention and not to limit the invention to the particular embodiment illustrated. It is intended that the scope of the invention be defined by all of the embodiments encompassed within the following claims and their equivalents.

### REFERENCES

Asefa, T.; MacLachlan, M. J.; Coombs, N.; Ozin, G. A. Periodic Mesoporous Organosilicas with Organic Groups Inside the Channel Walls Nature 1999, 402, 867-871.
Asefa, T.; MacLachlan, M. J.; Grondey, H.; Coombs, N.; Ozin, G. A. Metamorphic Channels in Periodic Mesoporous Methylenesilica. Angew. Chem., Int. Ed. 2000, 39, 1808-1811.
Asefa, T., Ozin, G. A., Grondey H., Kruk, M., Jaroniec, M. Recent developments in the synthesis and chemistry of periodic mesoporous organosilicas. Stud. Surf. Sci. Catal. 2002 141, 1.
Brinker, C. J.; Anderson, M. T.; Ganguli, R.; Lu, Y.; Process to form mesostructured films. U.S. Pat. No. 5,858,457.
Inagaki, S.; Guan, S.; Fukushima, Y.; Organic/inorganic complex porous materials. U.S. Pat. No. 6,248,686.
Kresge, C. T., Leonowicz, M., Vartuli, J. C., Beck, J. C. Ordered mesoporous molecular sieves synthesized by a liquid-crystal template mechanism. Nature 359, 710-712 (1992)
Kuroki, M.; Asefa, T.; Whitnal, W.; Kruk, M.; Yoshina-Ishii, C.; Jaroniec, M.; Ozin, G. A. Synthesis and Properties of 1,3,5-Benzene Periodic Mesoporous Organosilica (PMO): Novel Aromatic PMO with Three Point Attachments and Unique Thermal Transformations J. Am. Chem. Soc. 2002, 124, 13886-13895.
Landskron, K.; Hatton, B. D.; Perovic, D. D.; Ozin, G. A. Periodic Mesoporous Organosilicas Containing Interconnected [Si(CH₂)]₃ Rings Science 2003, 302, 266-269.
Lu, Y.; Ganguli, R.; Drewien, C. A.; Anderson, M. T.; Brinker, C. J.; Gong, W.; Guo, Y.; Soyez, H.; Dunn, B.; Huang, M. H.; Zink, J. I. Continuous Formation of Supported Cubic and Hexagonal Mesoporous Films by Sol-gel Dip-coating Nature 1997, 389, 364-368.
Lu, Y.; Fan, H.; Doke, N.; Loy, D. A.; Assink, R. A.; LaVan, D. A.; Brinker, C. J. Evaporation-Induced Self-Assembly of Hybrid Bridged Silsesquioxane Film and Particulate Mesophases with Integral Organic Functionality. J. Am. Chem. Soc. 2000, 122, 5258-5261.
Maex, K.; Baklanov, M. R.; Shamiryan, D.; Iacopi, F.; Brongersma, S. H.; Yanovitskaya, Z. S. Low Dielectric Constant Materials for Microelectronics J. Appl. Phys. 2003, 93, 8793-8841.
Miller, R. D. In Search of Low-k Dielectrics Science 1999, 286, 421-423.
Nakata, R.; Yamada, N.; Miyajima, H.; Kojima, A.; Kurosawa, T.; Hayashi, E.; Seo, Y.; Shiota, A.; Yamada, K.; Method of forming insulating film and process for producing semiconductor device. U.S. Pat. No. 6,558,747.
Ogawa, M. A Simple Sol-gel Route for the Preparation of Silica-Surfactant Mesostructured Materials Chem. Commun. 1996, 1149-1150.
Shea, K. J.; Loy, D. A; Webster, O. Arylsilsesquioxane Gels and Related Materials. New Hybrids of Organic and Inorganic Networks. J. Am. Chem. Soc. 1992, 114, 6700-6710.
Stein, A. Advances in Microporous and Mesoporous Solids—Highlights of Recent Progress. Adv. Mater. 2003, 15, 763-775.
Landskron, K., & Ozin, G. A. Periodic mesoporous dendrisilicas. Science, 2004. 306(5701), 1529-1532.

TABLE 1

| Material | E (GPa) | H (GPa) |
|---|---|---|
| silica | 10.0 +/− 1.38 | 0.44 +/− 0.07 |
| methene | 12.7 +/− 3.1 | 0.51 +/− 0.06 |
| ethene | 13.3 +/− 2.2 | 0.77 +/− 0.06 |
| 3-Ring | 11.8 +/− 2.1 | 0.67 +/− 0.04 |

1. A method of treating a material comprising a metal oxide framework containing organic groups each bridging at least two metal atoms to increase a hydrophobicity and decrease a dielectric constant of said material, the method comprising the step of;
applying an effective treatment to cause a hydroxyl group-consuming chemical transformation of at least some of said organic groups from a bridging to a terminal configuration, wherein applying said effective treatment increases a hydrophobicity of said material and decreases a dielectric constant of said material.

2. The method according to claim 1 wherein said material comprising a metal oxide framework containing organic groups each bridging at least two metal atoms includes bridged organosilicas.

3. The method according to claim 2 wherein said bridged organosilicas include periodic mesoporous organosilicas (PMOs).

4. The method according to claim 1 which is porous, having one of a mesoporous structure having pores with a mean pore diameter in the range from less than 1 to about 50 nm and a macroporous structure with a mean pore diameter of at least 50 nm.

5. The method according to claim 1 wherein said material is in a form which is one of a film, a powder, a monolith.

6. The method according to claim 1 wherein, wherein the step of applying an effective treatment includes heating to cause a hydroxyl group-consuming chemical transformation.

7. The method according to claim 6 wherein the step of heating includes heating to at least 200° C. for an effective period of time to affect said chemical transformation.

8. The method according to claim 6 wherein the step of heating includes heating the material in an atmosphere selected from the group consisting of air, nitrogen, helium, neon, argon, krypton, xenon, carbon dioxide and oxygen.

9. The method according to claim 1, wherein the step of applying an effective treatment includes optical, electrical, chemical or thermal means, including but not limited to ultraviolet radiation and oxidizing plasmas.

10. The method according to claim 1 wherein said dielectric constant is lowered to a value in a range from about 1.1 to about 3.0.

11. A material comprising a metal oxide framework containing organic groups produced by a method comprising the steps of:
synthesizing a metal oxide framework containing organic groups bridging at least two metal atoms; and
applying an effective treatment to cause a hydroxyl group-consuming chemical transformation of at least some of said organic groups from bridging to a terminal configuration.

12. A material produced by the method of claim 11, wherein the step of applying an effective treatment includes heating to cause a hydroxyl group-consuming chemical transformation.

13. The material produced by the method of claim 12 wherein the step of heating includes heating to at least 200° C. for an effective period of time to affect said chemical transformation.

14. The material produced by the method of claim 12 wherein the step of heating includes heating the material in an atmosphere selected from the group consisting of air, nitrogen, helium, neon, argon, krypton, xenon, carbon dioxide and oxygen.

15. A material produced by the method of claim 11, wherein the step of applying an effective treatment includes exposing the material to any one of ultraviolet radiation (UV) and an oxidizing plasma to cause a transformation of the organic groups from bridging to terminal.

16. A material produced by the method of claim 11, wherein the step of producing a metal oxide framework includes producing said metal oxide framework structured using an organic template.

17. A material produced by the method of claim 16 wherein the organic template is selected from the group consisting of labile organic groups, solvents, thermally decomposable polymers, small molecules, cationic surfactants, anionic surfactants, non-ionic surfactants, dendrimers, hyper branched polymers, block copolymers, polyoxyalkylene compounds, colloidal polymeric particles, and combinations thereof.

18. A material produced by the method of claim 11 which is formed as a film.

19. A material produced by the method of claim 11 which is formed as a powder.

20. A material produced by the method of claim 11 which is formed as a monolith.

21. A material produced by the method of claim 18 which has a dielectric constant in a range from about 1.1 to about 3.0,

22. The material produced by the method of claim 18, wherein the film is deposited by any one of spin-coating, dip-coating, printing, casting, silk-screen, ink-jet, evaporation and vapour deposition.

23. The material produced by the method of claim 18 wherein the film has a thickness of at least 10 nm.

24. The material produced by the method of claim 18, having a refractive index of at least 1.15.

25. The material produced by the method of claim 18 having a Youngs modulus of at least 3 GPa.

26. A material produced by the method of claim 11 wherein a hydrophobicity of the material is increased due to the chemical transformation.

27. A material produced by the method of claim 11 which is porous.

28. A material produced by the method of claim 27 which has a mesoporous structure having pores with a mean pore diameter in the range from less than 1 to about 50 nm.

29. A material produced by the method of claim 27 which has a macroporous structure with a mean pore diameter of at least 50 nm.

30. A material produced by the method of claim 27 having a periodic arrangement of pores and a mean pore spacing of at least 2 nm.

31. The material produced by the method of claim 27 which has a periodic unit cell symmetry selected from the group consisting of a 2-dimensional hexagonal structure, a 3-dimensional hexagonal structure, a cubic structure, and a lamellar or porous lamellar structure.

32. The material produced by the method of claim 27 having a non-periodic arrangement of pores.

33. The material produced by the method of claim 27 wherein a porous volume of the porous material is in a range from about 0 to about 90 vol %.

34. The material produced by the method of claim 27, having a film morphology which is a continuous layer or collection of particles aggregated into a layer.

35. The material produced by the method of claim 11, wherein the organic group is selected from group consisting of an alkylene group, an alkenylene group, alkynylene, phenylene group, hydrocarbons containing a phenylene group, and organic groups derived from compounds having at least one carbon atom.

36. The material produced by the method of claim 11, wherein the metal atoms are selected from the group consisting of silicon, germanium, titanium, aluminum, indium, zirconium, tantalum, niobium, tin, hafnium, magnesium, molybdenum, cobalt, nickel, gallium, beryllium, yttrium, lanthanum, lead and vanadium and mixed metals.

37. A periodic porous organosilica material wherein no other terminal groups are present but terminal organic groups bound to the Si atom by a Si—C bond.

38. The material according to claim 37 comprising a metal oxide framework containing uniformly distributed terminal organic groups.

39. The material according to claim 37 which has a hydrophobic resistance to moisture adsorption.

40. The material according to claim 37 which has a dielectric constant in a range from about 1.1 to about 3.0.

41. The material according to claim 37 which has a dielectric constant in a range from about 1.6 to about 2.2.

42. The material according to claim 37 which has a Youngs modulus of at least 3 GPa.

43. The material according to claim 37 which is formed as a film, powder or monolith.

44. The material according to claim 37 which is porous.

45. The material according to claim 44 which has a mesoporous structure having pores with a mean pore diameter in the range from less than 1 to about 50 nm.

46. The material according to claim 44 which has a macroporous structure with a mean pore diameter of at least 50 nm.

47. A material produced by the method of claim 18 wherein said dielectric constant is lowered to a value in a range from about 1.6 to about 2.2.

48. The method according to claim 1 wherein said dielectric constant is lowered to a value in a range from about 1.6 to about 2.2.

49. The method of claim 1, wherein the organic group is selected from group consisting of an alkylene group, an alkenylene group, alkynylene, phenylene group, hydrocarbons containing a phenylene group, and organic groups derived from compounds having at least one carbon atom.

50. The method of, claim 1 wherein the metal atoms are selected from the group consisting of silicon, germanium, titanium, aluminum, indium, zirconium, tantalum, niobium, tin, hafnium, magnesium, molybdenum, cobalt, nickel, gallium, beryllium, yttrium, lanthanum, lead and vanadium.

51. The material produced by the method of claim 11 which exhibits a hardness greater than 0.5 GPa.

52. The material according to claim 37 which exhibits a hardness greater than 0.5 GPa.
